(19) United States
(12) Patent Application Publication
(10) Pub. No.: US 2015/0261825 A1
(43) Pub. Date: Sep. 17, 2015

(54) Determination of the Suitability of a Resource

(71) Applicant: SIEMENS AKTIENGESELLSCHAFT, München (DE)

(72) Inventors: Jan-Gregor Fischer, Zorneding (DE); Mikhail Roshchin, Feldkirchen (DE)

(21) Appl. No.: 14/412,676

(22) PCT Filed: Jun. 28, 2013
(86) PCT No.: PCT/EP2013/063610

§ 371 Date: Jan. 3, 2015

(30) Foreign Application Priority Data
Jul. 3, 2012 (DE) 10 2012 211 511.0

(51) Int. Cl. G06F 17/30

(52) U.S. Cl. CPC G06F 17/30507; G06F 17/30864

(57) ABSTRACT

According to the invention, a resource, which could optionally be used for a maintenance task of a technical system, is taken into consideration and the possible use thereof is checked even if not all conditions that would be required as per a model description of the resource are met. Thus, a compromise for a resource that comes closest to the sought resource, i.e. is as suitable as possible, can be found in an automated and efficient manner. The invention can be used, for example, for maintenance tasks of large and complex technical systems, for example, in automation technology or production technology.

The invention relates to a method and apparatus for the determination of the suitability of a resource in a technical system.

Ontologies in information technology are linguistically recorded and formally ordered representations of a group of concepts and their interrelationships in a particular domain of discourse. They are used to exchange “knowledge” in digitized and formal form between application programs and services. Knowledge here comprises both general knowledge and knowledge about very specific topics and procedures. Ontologies contain inference and integrity rules, i.e. rules for deduction and for ensuring their validity (cf. http://de.wikipedia.org/wiki/Ontologie_%28Informatik%29).

An abduction mechanism is, for example, known from [Thomas M. Hubauer, Steffen Lamparter, Michael Pirker. Automata-Based Abduction for Tractable Diagnosis. Proceedings of the DL Home 23rd International Workshop on Description Logics (DL 2010), vol. 573 of CEUR Workshop Proceedings, pp. 360-371. CEUR-WS.org, 2010], and a relaxed abduction mechanism is, for example, known from [Thomas M. Hubauer, Steffen Lamparter, Michael Pirker. Relaxed Abduction: Robust Information Interpretation for Incomplete Models. Proceedings of the DL Home 24th International Workshop on Description Logics (DL 2011), vol. 745 of CEUR Workshop Proceedings, CEUR-WS.org, 2011].

In the resources planning of a maintenance process, it is necessary for employees, materials and machines, amongst other things, to be assigned to the systems to be maintained. It is in particular necessary here in the case of missing and/or over-fulfilled properties of resources required for the maintenance, as well as in case of a plurality of resources coming into question for the maintenance, to effectively determine which resources will be used for which maintenance orders.

The manual assignment of resources to maintenance orders is known. For example, responsible employees use their experience, assisted by additional information (e.g. earlier schedules for resource utilization planning, tables to represent employees and materials at particular systems requiring maintenance) in order to perform resources selection.

When using CMMS (Computerized Maintenance Management Systems) automated methods are sometimes utilized to create a rule-based list of these representations as a basis on which responsible employees can make a decision.

The rules are here usually formulated in an “if-then” form in such a way that the rule precondition contains the system (or its category) to be maintained, and the rule postcondition selects the resource. Depending on the detail in which the resource utilization is to be planned, it may be that only a few rules are adequate (rough planning on the level of categories of systems to be maintained, with known faults and resources utilized), or it may be that a very large number of rules are necessary (fine planning on the level of system instances to be maintained, with known faults and individual machines, materials and workers known by name).

Particularly when used for fine planning, systems of this sort soon run up against their limits, due to the very high effort required to maintain the rules. New systems, employees, machines and materials that are relevant to the maintenance must be incorporated in the form of rules, rules that are no longer current must be removed, and existing rules may need to be edited in response to changes in the maintenance process.

In addition, effective resources planning that takes uncertain information into account is not always possible, since the assignment rules under preconditions that are not entirely known (e.g. unknown faults in the system) and/or postconditions that are not entirely known (e.g. unknown suitability of a resource) cannot, for technical reasons be actuated. In such cases, the planning must be completed manually. The derivation direction of rule-based systems is moreover crucial for functionality. In the above-mentioned case, system faults are represented in the resources necessary for the maintenance.

When restrictions on the resources are taken into account, it is in addition necessary to undertake the derivation direction of resources to system faults. For this purpose, constraint-based techniques are sometimes utilized nowadays (a constraint corresponds to a restriction, given, e.g. in the form of an auxiliary condition), but as in the case of the rule-based method described previously, can nevertheless not work with uncertain information, and are also affected by the other disadvantages, such as the poor scalability and the complex system maintenance.

The object of the invention is to avoid the above-mentioned disadvantages and, in particular, to create an efficient approach to the utilization of resources in a technical system.

This object is achieved through the features of the independent claims. Preferred embodiments can in particular be taken from the dependent claims.

To achieve the object, a method for determining the suitability of a resource in a technical system is given,
in which at least one resource is determined which breaches at least one condition of a model,
in which the suitability of the at least one resource is determined.

It is thus possible to assign or to use a resource even when it does not satisfy or breaches a defined condition of the model. In this case, a next-best-fitting resource can be determined automatically and utilized, in particular for the case in which there is a plurality of alternatives and none of the alternatives fits perfectly. For instance, all those resources that breach at least one condition of the model can be prioritized, and then the resource that represents the best compromise for utilization or use in the technical system can be displayed and/or selected.

The resource can be any arbitrary component or part (e.g. a spare part) of the technical system. The resource can also be a resource that is necessary for a procedure, e.g. an engineer who is required for a maintenance order.

The technical system can be a technical installation, a fabrication facility, a process supervision, a power station or the like.

It is a development that the resource is assigned or utilized provided the suitability corresponds to a predefined criterion.

It is for example possible to determine by means of a threshold value comparison whether the resource that does not fit perfectly is nevertheless assessed as suitable and can therefore, for example, be utilized as a spare part.

Another development is that the at least one resource breaches the at least one condition of the model when the at least one resource exhibits at least one additional, changed or reduced property.

For example, the resource can exhibit a material that is different from a predetermined specification (condition). If the resource is, e.g. a maintenance engineer, the engineer may have knowledge that differs from the required qualification, and in some cases nevertheless may be utilized as a maintenance engineer for a particular task, e.g. for the exchange or repair of a pump.

In particular it is a development that the suitability of the resource is determined with reference to predefined data relating to the properties for the resource.

For example, predefined data relating to a material, a level of knowledge etc. may be made available as a resource in order thus to achieve a comparability or exchangeability of the properties. For example, a scalar magnitude can be used, e.g. over a value range from 0 to 1, indicating whether in the system to hand a material A can be replaced by a material B (e.g. “1” indicates that replacement is not an option, while a value “0” indicates that it is irrelevant whether material A or B is used). Thus e.g. the scalar magnitude can be stored in a database, giving a value for the comparability of materials A and B. With reference to the value, a conclusion can be drawn, for instance through a threshold value comparison with a predefined minimum agreement, as to whether material A for a component that needs to be exchanged consisting of material B can be utilized. This approach applies correspondingly also to properties other than the “material”, referred to here by way of example, e.g. to a level of knowledge of an engineer, a performance of a component, a current consumption, etc.

This approach has the advantage that the model can comprise a description according to which a component consists e.g. of material A, without the need for the description of the model in the first place to take account of which alternative materials also come into question. The description can thus use the existing information about the components, and describe them as fully as possible. The present invention makes it possible to establish automatically at a later point in time whether the component of material B comes into question as a replacement component, in that the comparison of the properties is carried out with reference to predetermined data.

It is also a development that the suitability of the resource is determined by an abduction mechanism, in that resources that come into question hypothetically are examined for their suitability.

The resource that comes hypothetically into question is a resource that breaches at least one condition of a model.

Optionally the resources that come into question can be prioritized.

This is in particular advantageous if it is determined for a large number of resources whether they would be suitable. On the basis of the comparison, explained above, with predefined data relating to the properties of the resources that come into question, it is possible to output a value (e.g. between 0 and 1) for their suitability, and to sort the resources that come into question according to this value.

Optionally the prioritized resources can be displayed.

In the context of a further development, the most highly prioritized resource is used, i.e. e.g. utilized in the technical system or assigned to it.

A next development consists in that the model comprises description logic rules of a knowledge base, as well as an instantiated technical system, in particular in the form of an ontology.

The description logic rules can be summarized in a definition, also known as a TBox, and the instantiated technical system in an ABox. Both the TBox and the ABox represent a knowledge base, for example in the form of a formal, axiomatic description of, e.g. maintenance orders, resources and relationships. An ontology, e.g. OWL (Web Ontology Language) can for example be utilized for this.

In addition it may be noted that the abduction mechanism can, for example, comprise a selection mechanism and a prioritization mechanism. Provision of the selection mechanism can here be optional. The abduction mechanism preferably supplies a resource utilization priority, which can be used by a following resource utilization mechanism in order to plan or carry out the resource utilization.

The resource utilization mechanism can, for example, adapt the instantiated technical system according to the ABox corresponding to the determined resource utilization.

In one design, the resource is assigned or utilized in the context of a maintenance order for a technical system.

Other application examples for the solution presented here are correspondingly possible.

The present object is also achieved by means of an apparatus for determining the suitability of a resource in a technical system with a processing unit that is configured such that
at least one resource can be determined, which breaches at least one condition of a model,
the suitability of the at least one resource can be determined.

The above object is also achieved by means of a system comprising at least one such apparatus.

The explanations made above relating to the method apply correspondingly also to the apparatus and to the system.

The solution presented here furthermore comprises a computer program product which can be loaded directly into a memory of a digital computer, comprising program code elements that are suitable for carrying out the steps of the method described here.

Furthermore, the above-mentioned problem is solved by means of a computer-readable storage medium, e.g. any appropriate memory, comprising instructions that can be executed by a computer (e.g. in the form of program code) that are suitable for the computer to perform the steps of the method described here.

The properties, features and advantages described above of this invention, as well as the manner in which these are achieved, will be explained more clearly, and significantly more understandably, in association with the following schematic description of exemplary embodiments which are explained more closely in association with the drawings. For the sake of clarity, elements that are identical or have the same effect are here given the same reference signs.

Here:

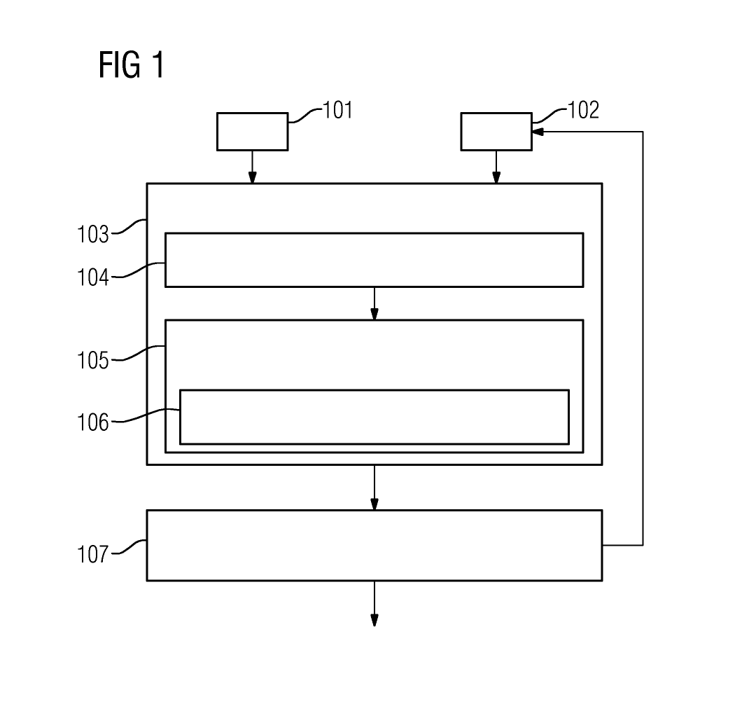

FIG. 1 shows a schematic diagram for illustrating the assignment of resources to maintenance orders taking uncertain resource information into account;

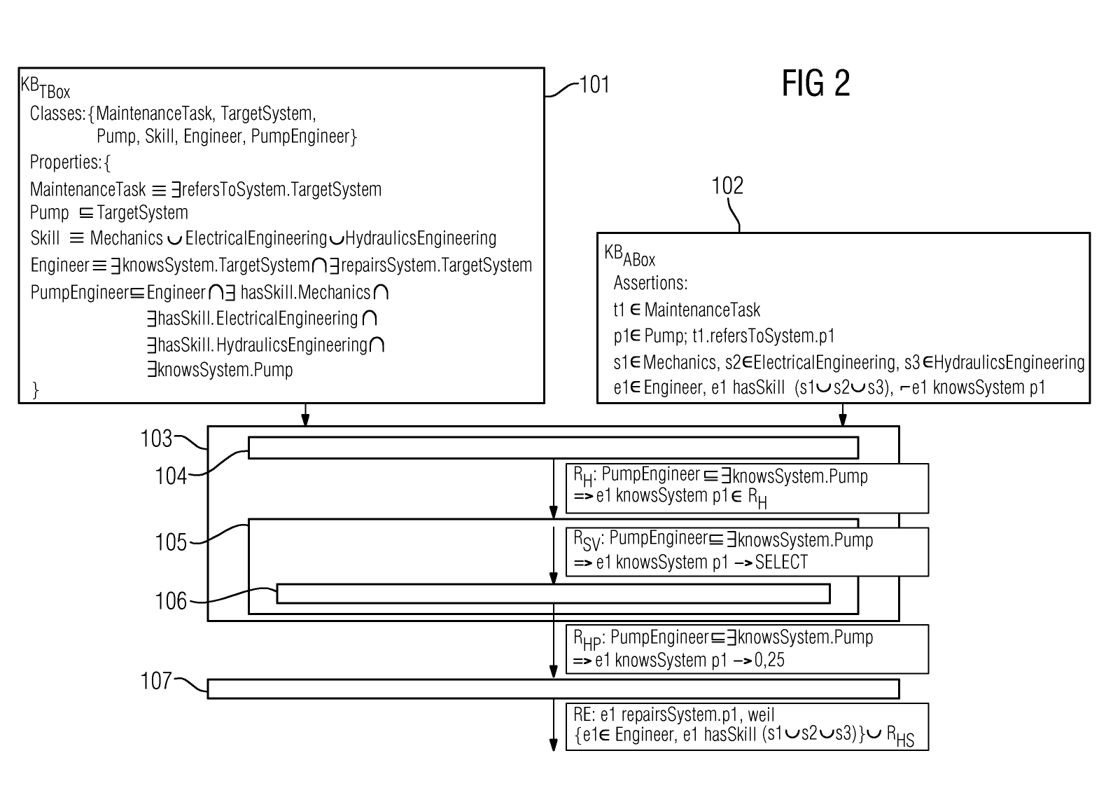

FIG. 2 shows a schematic diagram for an example of the assignment of a maintenance engineer for the repair of a pump, wherein the maintenance engineer does not have the property required according to TBox that he is familiar with the repair of pumps;

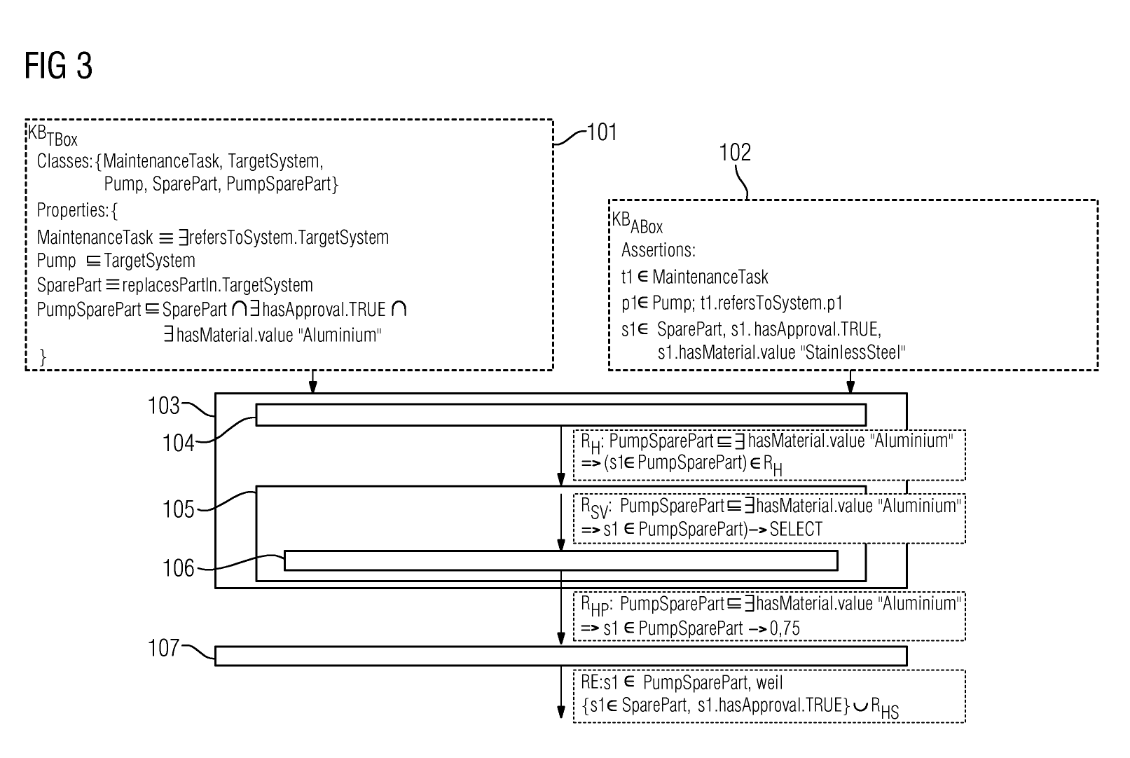

FIG. 3 shows a schematic diagram for another example of the assignment of a spare part for the repair of a pump, although the spare part comprises a different material from that which is intended for the maintenance process.

The solution presented here permits an efficient resources planning and/or resource assignment of a technical system or for a technical system, taking uncertain information into account. This is achieved, for example, with the technical mechanisms explained below.

A KB_{TBox} comprises description logic rules (TBox) in a knowledge base KB, preferably in the form of an ontology description language OWL (Web Ontology Language) for the formal, axiomatic description of resources, maintenance orders and their mutual relationships (in particular with reference to the systems and faults defined in maintenance orders).

A KB_{ABox} represents available resources R and outstanding maintenance orders WA in the form of individuals which, in accordance with KB_{TBox} are preferably described axiomatically in the ontology description language OWL (Web Ontology Language).

A indicates an abduction mechanism with hypothesis formation for the logic-based identification of all the resources hypothetically coming into question for the maintenance

R_{H}⊂KB_{ABox},

wherein R_{H} contains the resources from R whose properties, in accordance with the description logic modeling rules in KB_{TBox} cannot directly be modeled onto the maintenance orders in WA. This means that only actually available resources from R are considered, whose properties are nevertheless hypothetical, and are completed in accordance with KB_{TBox}.

A hypothesis formation mechanism HB (also referred to as hypothesis conditions) of the abduction mechanism A, analyzes resources R_{H} which
(a) are available,
(b) which permit, through additional, changed or reduced properties/property values in the combination of the properties of resources in KB_{ABox}, the logical deduction of maintenance orders from the set WA.

This makes it possible for the hypothesis formation mechanism HB to allow that hypothetical resources from R_{H} do not have to completely satisfy all the preconditions necessary for the resource utilization for WA.

A selection mechanism C of the abduction mechanism A selects, on the basis of the hypothesis formation results in R_{H} the identified, hypothetical resources in accordance with a selection rule SV, and thus refines the result set of hypothetical resources

R_{SV}⊂R_{H}⊂KB_{ABox},

which describe the later, concrete resource utilization.

The selection conditions can be described as follows:
KB_{TBox} AND KB_{ABox} AND R_{SV} is unobjectionable;
KB_{TBox} AND KB_{ABox} AND R_{SV} satisfies the conditions of WA.

The term “AND” here represents a logical AND combination.

A prioritization mechanism B of the selection mechanism C assigns a resource utilization priority R_{HP}, on the basis of a predefined, adaptable prioritization rule PV, each resource in R_{SV} identified by the selection, or its respective resource class, in accordance with its suitability with reference to the maintenance for a class of maintenance orders in WA and the systems and system faults found therein.

PV maps resource properties of R_{SV} depending on the possible utilization for maintenance orders in WA onto a priority, e.g.

PV(r_{SV}εR_{SV},wεWA)→{0, . . . ,1},

wherein a low value signifies for example a low priority (and thereby a very probable utilization of the resource for the individual maintenance order w) and a high value for example a high priority (and thereby a very unlikely utilization of the resource for the individual maintenance order w).

A resource utilization execution mechanism E either performs the resource utilization RE automatically by booking the resources in a potentially external information system (e.g. ERP, SAP, CMMS), or provides a visual display of e.g. a summarized list of RE—possibly with explanation on the basis of a procedure report based on KB_{TBox}, KB_{ABox}, A, HB, C including B—to a decision-making person for manual resource approval. In both cases, a resource utilization RE′ (which can perhaps be no resource utilization, in which case RE′ is the empty set) is made in the information system.

FIG. 1 shows a schematic diagram to illustrate the assignment of resources to maintenance orders, taking uncertain resource information into account.

Description logic rules KB_{TBox} 101 and available resources R, as well as maintenance orders in the form of individuals, axiomatically described as KB_{ABox} 102 are made available to an abduction mechanism 103.

The abduction mechanism 103 comprises a hypothesis formation mechanism HB 104, which, through the abduction mechanism A, supplies resources R_{H} determined in accordance with

A(KB_{TBox},KB_{ABox})→R_{H}

and a selection mechanism C 105. The selection mechanism C 105 determines the result set of hypothetical resources R_{SV} in accordance with

C(R_{H},SV)→R_{SV}

by means of the selection rule SV.

The selection mechanism C 105 comprises a prioritization mechanism B 106, which, on the basis of the hypothetical resources R_{SV} by means of the prioritization rule PV determines the resource utilization priority R_{HP} in accordance with

B(R_{SV},PV)→R_{HP}.

The resource utilization priority R_{HP} is supplied to a resource utilization execution mechanism E 107, which determines from this a summarized list of the resources RE and adapts KB_{ABox} in accordance with

E(KB_{TBox},KB_{ABox},R_{HP})→New_KB_{ABox}

RE⊂New_KB_{ABox}.

The approach presented combines the known abduction mechanism (“abductive reasoning”) with the automated assignment of resources to maintenance orders, taking uncertain resource information into account.

The concept presented has, for example, the advantage that a specification of the information required for the maintenance can be made with reference to an ontological description. It is furthermore possible that the formation and processing of hypothetically assumed preconditions is performed for the subsequent derivation of resources to maintenance orders. In this way, uncertain information such as hypothetical resource properties can be taken into account; for example, for a maintenance process with a fixed definition, resources that can be used as alternatives (e.g. maintenance engineers with only partially appropriate abilities, or materials and machines with similar properties) can be planned in automatically.

The solution presented permits the recognition of different resources as potentially capable of utilization, i.e. as coming into question for the maintenance. A prioritization, with subsequent selection of particular resources from this set, can thus be carried out, with the aim of optimizing resources and costs over maintenance activity.

The resources selected in accordance with a defined rule can either be assigned automatically to the maintenance orders, or can be displayed to a responsible employee as a suggestion for approval. This automated assignment, or the suggestion that has been determined, can already take into account the overreaching maintenance optimization depending on the actual resource situation.

The solution is scalable and easy to maintain. This is given through the use of formal specifications (description logic ontologies) and their model-independent, automated evaluation by means of logic-based abduction procedures.

FIG. 2 shows a schematic diagram for an example of the assignment of a maintenance engineer for the repair of a pump, wherein the maintenance engineer does not have the property required according to TBox that he is familiar with the repair of pumps.

The formal definition is located in the KB_{TBox} 101, and there is an exemplary initialization in the KB_{ABox} 102. In other words, the KB_{TBox} 101 represents the description logic rules of a model, for which a concrete, exemplary possible instantiation is given in the form of the KB_{ABox} 102. Properties are described here in the form of binary relationships between two classes, or between a class and a data type.

First of all, the description logic rules KB_{TBox} 101 are explained:

The following classes are given in FIG. 2:
a maintenance order (“MaintenanceTask”),
a target system (“TargetSystem”),
a pump (“Pump”),
an ability (“Skill”),
an engineer (“Engineer”),
a pump engineer (“PumpEngineer”).

The following properties are given in FIG. 2:
The maintenance order is defined as equivalent to all the individuals of classes that are modeled via a relationship “refersToSystem” to a target system class (“TargetSystem”), i.e. which relate to the target system. The individual that satisfies this “refersToSystem” relationship is thus a maintenance order.
The pump is a proper subset of a target system.
The ability is defined as knowledge of mechanics (“Mechanics”), electrical engineering
(“ElectricalEngineering”), and/or hydraulics engineering
(“HydraulicsEngineering”).
The engineer is defined as equivalent to all the individuals of classes that are modeled via the relationship “knowsSystem” to a class of the target system, i.e. that know the target system. In addition, the engineer is defined as equivalent to all the individuals of classes that are modeled via the “repairsSystem” relationship to a class of the target system, i.e. are able to repair the target system.
The pump engineer is a proper subset of the engineer. He is therefore an engineer. At the same time the pump engineer must exhibit the following abilities (i.e. satisfy the “hasSkill” relationships):
   knowledge of mechanics,
   knowledge of electrical engineering,
   knowledge of hydraulics.
In addition, a “knowsSystem” relationship for the pump should be satisfied for the individual pump engineer; in other words, the pump engineer must know the pump.

The KB_{ABox} 102, i.e. the concrete, actual instantiation at a particular point in time of available components and their relationships to one another, is described below. By way of example, FIG. 2 contains the following assignments (“Assertions”):
The individual t1 is a maintenance order.
The individual p1 is a pump.
   The relationship “refersToSystem” applies between the maintenance order t1 and the pump p1, i.e. the concrete maintenance order t1 is modeled onto the concrete system pump p1 with the “refersToSystem” relationship. This is permissible in accordance with the definition of TBox.
   The abilities of mechanics s1, electrical engineering s2 and hydraulics s3 are also defined.
   The individual e1 is an engineer. The engineer e1 has the abilities s1, s2 and s3. The engineer does not, however, know the pump p1.

The hypothesis formation mechanism 104 assumes hypothetically that the engineer e1 would know the pump p1. To this extent, the hypothesis formation mechanism 104 supplies the engineer e1 as a possible candidate for repair of the pump p1, and is selected by the selection mechanism 105 as a hypothetical resource R_{SV}. The prioritization mechanism 106 determines the associated resource utilization priority R_{HP}, which here, by way of example, has a value of 0.25. The resource utilization execution mechanism 107 utilizes the engineer e1 by way of example as a resource in the technical system (in this context, R_{HS} signifies that the engineer e1 knows the pump p1: e1 knowsSystem p1”). In particular in this way a selection of the most appropriate resource can be made from a large number of resources.

FIG. 3 shows a schematic diagram of another example of the assignment of a spare part for the repair of a pump, although the spare part comprises a different material from that which is intended for the maintenance process.

First of all, the description logic rules KB_{TBox} 101 are explained:

The following classes are given in FIG. 3:
a maintenance order (“MaintenanceTask”),
a target system (“TargetSystem”),
a pump (“Pump”),
a spare part (“SparePart”),
a spare pump part (“PumpSparePart”).
The following properties are given in FIG. 3: The maintenance order is defined as equivalent to all the individuals of classes that are modeled by a “refersToSystem”
relationship to a class target system (“Target-System”). The individual that satisfies this “refersToSystem” relationship is thus a maintenance order.
The pump is a proper subset of a target system.
The spare part is the set of all the individuals that are modeled by the relationship “replacesPartIn” onto an individual of the class target system.
The spare pump part is a proper subset of the spare part. It is thus a spare part. At the same time the spare pump part must satisfy the condition that it satisfies at least one “hasApproval” relationship (i.e. has a (technical) approval in the example—indicated by the value “TRUE”), and that this individual at the same time satisfies a “hasMaterial” relationship that is modeled onto a data type, wherein the value of the data type is “Aluminium”. In other words, the spare pump part should be a spare part which is a permissible spare part and which consists of aluminum.

The KB_{ABox} 102, i.e. the concrete, actual instantiation at a particular point in time of available components and their relationships to one another is described below. By way of example, 3 contains the following assignments (“Assertions”):
The individual t1 is a maintenance order.
The individual p1 is a pump.
The “refersToSystem” relationship applies between the maintenance order t1 and the pump p1, i.e. the maintenance order t1 is modeled onto the system pump p1 with the “refersToSystem” relationship. This is permissible in accordance with the definition of TBox.
The individual s1 is a spare part. The spare part s1 has a “hasApproval” approval. Furthermore, the spare part s1 has a “hasMaterial” relationship that models onto a data type, the value of which is stainless steel (“StainlessSteel”). This last relationship is not compatible with the definition of TBox, according to which the material of the pump has to be aluminum.

The hypothesis formation mechanism 104 assumes hypothetically that the pump that is available as a spare part consists of aluminum, although in fact it consists of stainless steel. To this extent, the hypothesis formation mechanism 104 supplies the pump s1 as a potential spare part, which is selected by the selection mechanism 105 as a hypothetical resource R_{SV}. The prioritization mechanism 106 determines the associated resource utilization priority R_{HP}, which here, by way of example, has a value of 0.75. The resource utilization execution mechanism 107 utilizes the pump s1 by way of example as a resource in the technical system (in this context, R_{HS} signifies that the pump s1 has the material property of aluminum: s1.hasMaterial.value “Aluminium”). In particular in this way, a selection of the most appropriate resource can be made from a large number of resources (in the example, only the case for the resource s1 is represented).

It is proposed that a resource which is perhaps usable for a maintenance order of a technical system, should also be considered, and its possible utilization checked, even if it does not fulfill all the conditions which would be required in accordance with a model description of the resource. A compromise can in this way be found automatically and efficiently for a resource that comes closest to the desired resource, i.e. which fits the requirements as well as possible. The invention can, for example, be utilized for maintenance orders for large, complex technical systems, e.g. in automation or manufacturing technology.

Although the invention has been illustrated more closely and described in detail through the at least one exemplary embodiment described, the invention is not restricted to that, and other variations can be derived from it by the person skilled in the art without leaving the protected scope of the invention.

1. A method for determining the suitability of a resource in a technical system,
in which at least one resource is determined which breaches at least one condition of a model (104),
in which the suitability of the at least one resource is determined (106),
in which the model includes description logic rules of a knowledge base as well as an instantiated technical system in particular in the form of an ontology.

2. The method as claimed in claim 1 in which the resource is assigned or utilized (107) provided the suitability corresponds to a predefined criterion.

3. The method as claimed in one of the preceding claims, in which the at least one resource breaches the at least one condition of the model when the at least one resource exhibits at least one additional, changed or reduced property.

4. The method as claimed in one of the preceding claims in which the suitability of the resource is determined with reference to predefined data relating to the properties for the resource.

5. The method as claimed in one of the preceding claims in which the suitability of the resource is determined by an abduction mechanism, in that resources that come into question hypothetically are examined for their suitability.

6. The method as claimed in claim 5 in which the resources that come into question are prioritized.

7. The method as claimed in claim 6 in which the prioritized resources are displayed.

8. The method as claimed in one of claims 6 and 7 in which the most highly prioritized resource is utilized or assigned.

9. The method according to one of the preceding claims in which the resource is assigned or utilized in the context of a maintenance order for a technical system.

10. An apparatus for determining the suitability of a resource in a technical system with a processing unit that is configured such that
at least one resource can be determined, which breaches at least one condition of a model,
the suitability of the at least one resource can be determined,
the model includes description logic rules of a knowledge base as well as an instantiated technical system in particular in the form of an ontology.

11. A computer program product which can be loaded directly into a memory of a digital computer, comprising program code elements that are suitable for carrying out the steps of the method as claimed in one of claims 1 to 9.

12. A computer-readable memory medium comprising instructions that can be executed by a computer that are suitable for the computer to perform the steps of the method as claimed in one of claims 1 to 9.
